(19) United States
(12) Patent Application Publication
(10) Pub. No.: US 2005/0266307 A1
(43) Pub. Date: Dec. 1, 2005

(54) Current collectors

(75) Inventors: Jon K. West, Gainesville, FL (US); Thomas J. McCall, Ft. White, FL (US); Thomas E. Audit, Alachua, FL (US)

Correspondence Address: MORRISON & FOERSTER LLP, 1650 TYSONS BOULEVARD, SUITE 300, MCLEAN, VA, 22102, US

(73) Assignee: WAVECREST LABORATORIES, Dulles, VA (US)

(21) Appl. No.: 10/853,767

(22) Filed: May 26, 2004

(51) Int. Cl. H01M 2/26

(52) U.S. Cl. 429/161; 29/2

(57) ABSTRACT

Disclosed is a current collector and method for increasing the electrical conductivity between the collector, casing, and the winding in the cell. The current collector comprises a sheet of highly conductive metal, such as pure nickel, having a plurality of protruding tabs arranged about its periphery. The tabs are folded upwardly to receive the winding and to fit inside the casing. The tabs are then welded to the casing, using a series welding technique through the outside of the casing.

### FIELD OF THE INVENTION

The present invention relates to current collectors for use in electrolytic energy storage devices, including energy storage devices having spiral-wound plates, such as D-Cell type batteries. Disclosed are examples of novel multiple-contact collectors and method for manufacturing such collectors.

### BACKGROUND OF THE RELATED ARTS

Batteries of the type relevant to the present invention are conventionally constructed with a set of anode plates and a set of interleafing cathode plates, which may be spirally wound and spaced apart by separators infused with an electrolyte. The anode plates may be electrically connected to the battery anode terminal, and the cathode plates may be electrically connected to the battery cathode terminal. These portions of the energy storage cell comprise the positive and negative terminals of the cell. For the sake of rigidity of the assembled sets of anode and cathode plates, the connection between the plates and the terminals is typically mechanical as well as electrical, and is accomplished with a current collector that can take various forms.

The electromechanical attachment of the anode and cathode plates to their respective current collectors can be labor intensive and can be a source of quality problems during battery construction. Ideally, the current assembly would rigidly support the plates to help prevent their deformation within the battery case and to resist vibrational damage to the plates and separators. Further, the current tab should preferably be formed of a material that is readily connectable to both the terminal and to the plates in a manner that assures an easy and dependable electrical and mechanical attachment. It is particularly important that the electrical connection to both the plates and the collectors be of the lowest resistance, or at least of a resistance no greater than the resistance in the plates and terminals themselves, so that the impedance of the connection is reduced and the current capacity is increased.

One desirable electrical characteristic of such batteries is a very high charge and discharge rate. A high charge and discharge rate requires high current carrying capacity in the electrical connection from the plates to the terminals, in order to both carry the load without reducing the charge and discharge rate and also to avoid resistive overheating that could structurally or electrically damage the battery.

The prior art discloses many types of end connectors that are designed to enhance the structural integrity or to minimize the electrical impedance of batteries. For example, U.S. Pat. No. 4,539,273 by Goebel describes a set of plates wound on a spool with an anode flange and a cathode flange. Each plate has a set of connecting tabs spaced along an edge, which is in electrical contact with the appropriate spool flange. The Goebel device does not provide for any secure mechanical connection between the spool flange and the plates. Also, the Goebel device would appear to require a fairly intricate manufacturing process, especially if used on a very thin plate battery having a very long plate edge that would require a large number of connecting tabs.

In U.S. Pat. No. 3,695,935 by Cromer, there is disclosed a spirally wound plate design where the anode plate is wound offset from the cathode plate so that the anode plate edge overhangs one edge of the spiral and the cathode plate edge overhangs the other edge of the spiral. The two overhanging edges are “ruffled”. The purpose of the ruffles is said to be to strengthen the edges against damage during manufacturing, to blunt the edges to reduce the potential for injuring manufacturing workmen, and to increase the conductivity between the plate and the terminal. The Cromer device uses an ordinary strap type end connector to join the plates to the terminal.

One of the more common arrangements for electrically connecting the plates to the terminals is shown in U.S. Pat. No. 3,862,861 by McClelland et al. In the structure shown by McClelland, the plates include spaced tabs on the plate edge so that the wound plate has a set of tabs protruding from an end. The protruding tabs are then joined together and connected to the current collector. The McClelland arrangement is difficult to construct, may allow for electrolyte leakage, and may not lend toward high conductivity.

An additional shortcoming of the prior art includes the manner in which the negative current collector is joined to the coiled negative electrode. Typically, the negative current collector abuts the negative spiral-wound plate. The negative plate is wound in a manner where it is offset from the positive plate to provide for an overhang that comes into contact with the negative current collector. The coil and negative current collector are then inserted into the can, and a welding electrode is carefully aligned and inserted through the center of the coil. The welding electrode then provides a single weld to attach the negative current collector to the can. It is this weld that provides the current path from the negative plate of the coil, through the negative current collector, to the can.

Illustrative collectors used in accordance with the prior art method are shown in FIGS. 4(a) and 4(b). FIG. 4(a) shows a circular collector having a plurality of weld projections and an integrated, central tab that is welded to a conductive casing which houses the electrode coil. FIG. 4(b) shows another circular collector which includes a protruding tab, a plurality of weld projections, and a central hole. When manufacturing a battery with the collector of FIG. 4(b), the collector is placed in contact with the offset portion of the negative electrode plate and is welded to the coil via the weld projections. The protruding tab is folded away from the coil and the coil is inserted into a conductive casing. A welding electrode is carefully aligned and inserted through the coil, further through the central hole in the collector, and a single weld point attaches the collector to the conductive casing. In addition to forcing the current to flow through a single weld point, the prior art method is labor intensive, time consuming, and prone to mechanical failure and high product rejection rates.

Further, by providing only a single weld, all of the current passes through a single point, raising the internal resistance of the battery cell. In turn, this may cause the battery to fail during periods of high-rate charge or discharge and leads to the generation of heat and potential cell failure if the single weld experiences electrical or mechanical failure.

Accordingly, by failing to provide for high conductivity at the current collectors, prior art devices can exhibit high effective resistance which, in turn, leads to higher heat discharge.

It is therefore desirable to provide a current collector that provides for a simplified manufacturing process that does not require welding through the electrolyte solution, or drilling or aligning holes in the cell casing.

It is also desirable to provide a current collector that has high conductivity with low resistance in a single cell energy source.

It is also desirable to provide a current collector that reduces temperature during discharge of a single cell energy source.

As well, it is desirable to provide a current collector that facilitates alignment and orientation of single cell energy sources when processed or assembled into multi-cell batteries.

### SUMMARY OF THE INVENTION

The present invention relates to a negative current collector for an energy storage cell. In particular, the negative current collector of this invention is a current collector having a plurality of tabs radially protruding from a central hub. The tabs may be folded upwardly to receive and wrap around the negative (cathode) plate of an electrolytic cell having coiled electrodes, the outer surface of which defining a curved portion. The central hub of the collector plate is then welded to the conductive edges of the windings of the electrical storage device at a plurality of points.

In a preferred embodiment of the invention, the tabs are welded to the can, or conductive casing, which houses the negative current collector, through the outer casing of the cell, by means of a series weld, laser, or other device. Those skilled in the art will readily recognize welding schedules that can be found to accommodate different thicknesses for the can, i.e., outer casing, and negative collector plate. In an illustrative embodiment of the invention, an exemplary weld may be performed by a series welding technique at, for example, about 4,000 amps for a time of approximately 4 ms. A precise welding schedule depending on the construction materials and thicknesses of each component, as well as the type of welding equipment used, can be readily determined by those of ordinary skill in the welding arts.

Further, the number of welds may be dependent upon the number of outwardly radiating tabs which protrude from the periphery of the negative current collector. It is preferred that the number of welds be N+1, where the number of tabs is N, an integer, to ensure that the majority of the welds, or current paths, secure the tabs to the conductive casing at a point other than where the tabs meet when upwardly folded to receive the winding. Alternatively, the number of current paths can be defined as M, an odd integer, when the number of tabs is N, an even integer.

In another preferred embodiment, the coil, current collector and container, i.e., the conductive casing or can, are radially symmetric. Such a configuration avoids the need to align the negative collector during the construction process. In this and other embodiments, the coil may be characterized as having an inner diameter and an outer diameter. The inner diameter is defined by the opening through coil and the outer diameter being defined by the outer edge of the coil. In one embodiment of the invention, the inner diameter and outer diameter define a ratio of not less than 6 to 1 (outer to inner).

### BRIEF DESCRIPTION OF THE DRAWING FIGURES

FIG. 1 illustrates an embodiment of the invention having a negative, radial current collector with upwardly folded tabs which are welded to the conductive casing.

FIG. 2(a) shows an embodiment of the negative, radial current collector of the present invention in top plan view, having a plurality of weld projections and outwardly radiating tabs.

FIG. 2(b) shows an embodiment of the invention wherein a plurality of negative radial current collectors are manufactured in a strip.

FIG. 2(c) illustrates in side plan view an embodiment of the negative radial current collector of the present invention wherein the outwardly radiating tabs are folded upward to receive a coiled energy storage device.

FIG. 2(d) illustrates in detail an exemplary weld projection of the negative radial current collector of the present invention.

FIG. 3(a) shows, in perspective, the negative radial current collector of the present invention wherein the outwardly radiating tabs are folded upward to receive a coiled energy storage device.

FIG. 3(b) shows an embodiment of the negative, radial current collector of the present invention in perspective view, having a plurality of weld projections and outwardly radiating tabs.

FIG. 4(a) shows a negative radial current collector of the prior art having a central tab.

FIG. 4(b) shows another negative radial current collector of the prior art which illustrates an outwardly protruding tab that may be folded over and welded to the conductive casing.

FIG. 5 shows an example of a coiled energy storage device in top plan view.

### DETAILED DESCRIPTION OF THE INVENTION

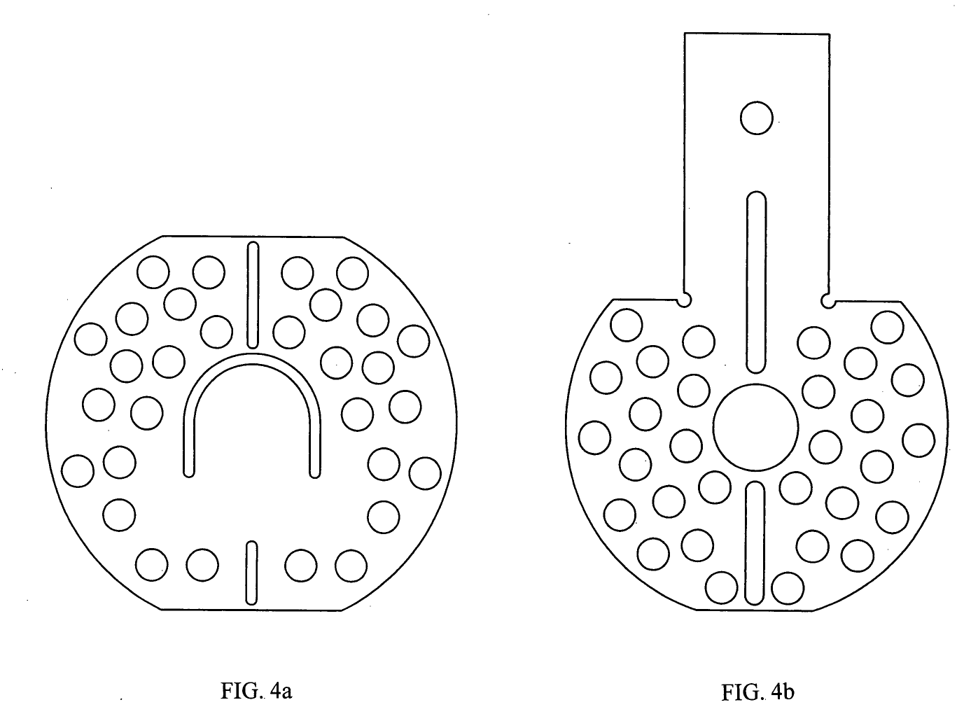

The present invention relates to an electrical energy storage device and, more specifically, to rechargeable storage cells such as D-Cell batteries. By way of example and illustration, the present specification describes D-Cell batteries. It is noted, however, each of the principles and discoveries mentioned herein apply with equal weight to cells having a coiled energy storage device, such as AA, AAA, C, and other such cells, such as those which do not use cylindrically wound coils like prismatic batteries, oval cells, etc. Particularly, the present invention is a novel negative current collector and method for securing the current collector to the battery cell casing and providing a low-resistance current path from the electrode coil to the casing. Although not limited to these advantages, the present invention overcomes the labor-intensive and failure-prone nature of prior art collectors, such as those illustrated in FIGS. 4(a)-(b), and provides for a battery that emits less heat during charge and discharge by having a lower internal resistance than prior art batteries.

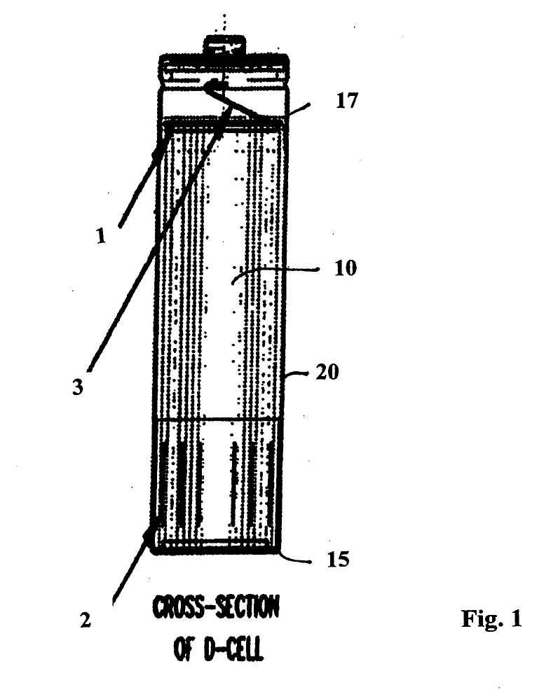

As illustrated by FIG. 1, an exemplary energy storage cell of the present invention includes a coiled energy storage device 10, a positive current collector 1, a positive current collector to cover tab 3, a negative current collector 2, and a conducting casing, or “can” 20. The can 20 is preferably chemically compatible with the electrochemistry of the storage device, and thus be substantially resistant and impermeable to the electrolyte used. Any such suitable material may be employed as the casing.

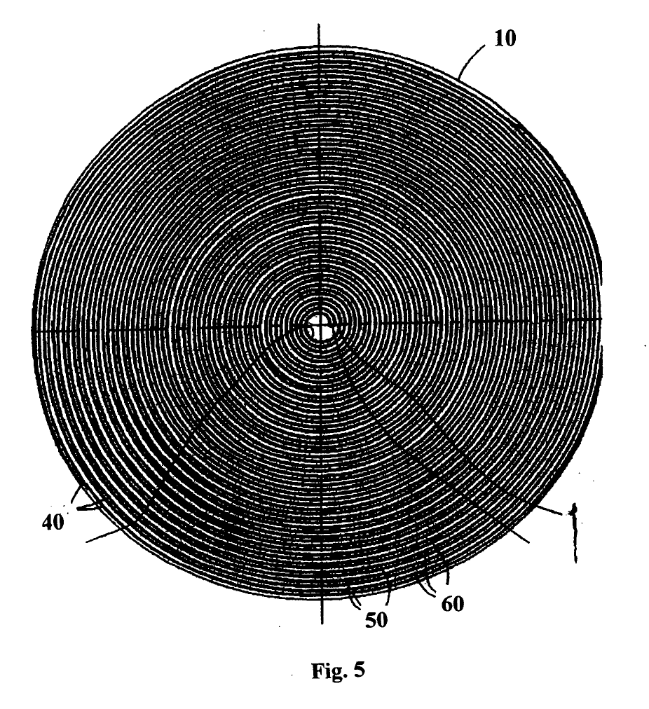

The electrical energy storage device, shown generally in FIG. 5 and noting that like parts are shown with corresponding reference numerals throughout the drawing figures, may comprise a coiled winding 10 having a cathode plate including a strip having a pair of elongated side edges, an anode plate including a strip having a pair of elongated side edges, and a separator located between the cathode and anode plates. Further, in an illustrative description of the energy storage device, it includes a coiled winding 10 made of three or four elongated rectangular strips wound together: a cathode plate 40, an anode plate 50 and a separator 60 (multiple separators may be used). The separator 60 is wound between the cathode plate 40 and the anode plate 50 along their entire lengths to prevent the plates from contacting each other. The cathode plate 40 and the anode plate 50 each have two elongated side edges which extend along the entire lengths of the longest sides of the plates. Exemplary energy storage devices and methods which relate to the present invention are described in U.S. Pat. No. 6,265,098, U.S. Pat. No. 5,667,907, U.S. Pat. No. 5,439,488, and U.S. Pat. No. 5,370,711, each of which is hereby incorporated by reference in its entirety.

To provide a surface upon which each of the current collectors can be attached to the energy storage device, the cathode plate and the anode plate may be wound in an offset relationship so that one elongated side edge of the cathode plate extends beyond one elongated side edge of the anode plate at a first side of the winding, and the other elongated side edge of the anode plate extends beyond the other elongated side edge of the cathode plate at a second side of the winding opposite the first side. The cathode plate and the anode plate are wound in an offset relationship so that the edge of the cathode plate extends beyond the edge of the anode plate at the circular first side of the winding. Similarly, at the circular second side of the winding, the other edge of the anode plate extends beyond the other edge of the cathode plate. Therefore, the edge of the cathode plate forms a spiral surface at the first side of the winding, and the edge of the anode plate forms a spiral surface at the second side of the winding.

Once the collectors are attached to the energy storage device and the device has been secured in the conductive casing, an electrolyte material is introduced within the winding. A liquid electrolyte material is located between the plates in the winding and saturates the separator. If the plates are porous, the electrolyte material may also enter the pores to improve the output of the winding. The electrolyte material is sealed within the casing to prevent leakage.

The electrolyte material allows the desired electrochemical reaction to occur within the winding. If the plates are made of nickel hydroxide and cadmium, the electrolyte material may comprise an aqueous alkaline solution such as potassium hydroxide. However, any suitable electrolyte which performs favorably in combination with the materials chosen as the plates may be used within the scope of the present invention.

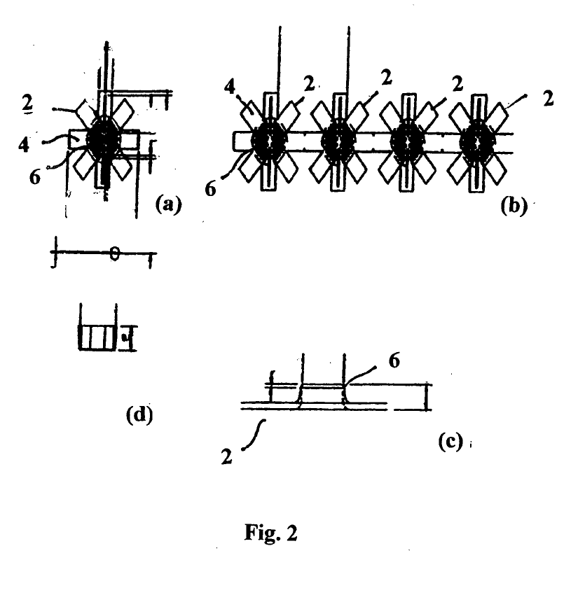

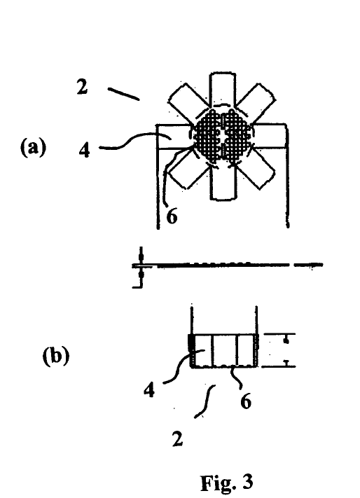

In accordance with an embodiment of the invention, two current collectors are secured to the casing, one current collector being pressed against the first side of the winding to contact the cathode plate at a plurality of locations thereon, and the other current collector being pressed against the second side of the winding to contact the anode plate at a plurality of locations thereon. As embodied in FIGS. 1 and 5, two current collectors 1 and 2 are pressed against the ends of the winding 10 to contact the respective plate edges. A negative current collector 2 is pressed against the first side 15 of the winding 10 to contact the cathode plate 40 and a positive current collector 1 is pressed against the second end 17 of the winding 10 to contact the anode plate 50. The offset relationship between the plates allows each current collector 1 and 2 to make direct electrical contact with a single plate without the need for tabs connecting the plates and collectors. However, in order to increase the current carrying capacity between the negative current collector and the cathode plate, it has been found to be advantageous to provide tabs that radially protrude from a central hub, or inner region of the collector, that can be folded to receive the cathode plate. The tabs provide an area for welding, and thereby creating current paths, the negative current collector to the conductive casing. Such a negative radial current collector is shown in FIGS. 2(a) and 3(a)-3(b) and are also described in greater detail, along with other aspects such cells in applicant's copending applications, U.S. Ser. Nos. ______, ______, and ______, which are hereby incorporated by reference in their entireties.

Preferably, at least the negative radial current collector may include an electrical conductor having a series of protrusions for electrically contacting multiple locations on an adjacent end of the winding. As shown in FIGS. 2(a) and 3(a)-3(b), the negative radial current collector 2 may comprise a metallic electrical conductor having a series of protrusions 6. The protrusions 6 electrically contact multiple locations on an adjacent end of the winding 10. FIG. 2(c) shows a detailed view of the protrusions, or weld projections, that contact the adjacent end of the winding and are welded thereto.

Further, as shown in FIG. 3(a), it is preferable to form the negative current collector 2 in a manner permitting tabs to be upwardly folded to wrap entirely around the energy storage device, as illustratively shown in FIG. 3(b). The collector 2 is formed with a plurality of tabs 4 arranged around its perimeter, thus forming a cup-like article. The winding is then inserted into the cupped negative collector and the plurality of weld projections are then welded to the negative coil 50. The energy storage device having the negative collector welded thereto is then inserted into a conducting casing, or can. Unlike conventional batteries in which the negative current collector is welded to the can through a small opening in the center of the winding core, the present invention permits the negative winding to be trapped within multiple sets of tabs on the negative radial current collector. These tabs, being capable of relative movement with respect to the first or inner region, tightly collapse around the winding and are welded to the conducting casing via a series weld from the outside of the can. Due to the constriction of the tabs within the conducting casing, or container, the tabs may exert force against the interior surface of the container. This method of assembly permits for much greater current capacity, perhaps as much as 10 to 20 times greater than when using conventional battery structures, due to the significant increase in the number of contact points through which current can flow from the negative electrode of the winding, through the current collector, into the casing. Although the present negative current collector is disclosed for use with the exemplary battery of the present invention, those skilled in the art will readily recognize how such a negative current collector and the welding technique described hereinafter, can be applied to various sorts of electrolytic and electrochemical energy storage cells.

In a preferred embodiment, a series welding technique is used to weld the tabs of the radial electrode to the inside of the casing. The tabs arranged around the perimeter of the radial electrode (i.e., the negative current collector) are folded to fit around the negative coil and inside the casing. The electrode and counter electrode are spaced apart (approximately 3/4 inch in an illustrative embodiment, although the spacing will change depending on the overall scale of the cell being formed). The casing may then be welded for about 4 milliseconds using a current of about 4,000 amps. This technique effectively wells the tabs of the radial electrode to the inside of the can in a secure manner that achieves high conductivity and structural integrity.

Further, the present welding technique allows for the negative current collector to be welded to the negative coil without having to create holes through the can or welding through the electrolyte solution. These welds may be made before the electrolyte is filled into the battery. As well this method avoids the need to weld through the top and middle of the can.

In one embodiment of a device in accordance with the present invention, the radial negative current collector is formed with six projecting tabs from pure nickel having a thickness of about 0.008 inches. Other highly conductive metals and alloys may be used, of course. The radial negative current collectors may be formed from a single sheet (or strip) of material and then separated at the time of use, to facilitate manufacturing. The projections are folded upward into a position through a die and punch where they may receive the coil and fit inside the casing, prior to each projection (i.e., tab) being welded through the casing.

In the present example, the negative current collector of the present invention is illustrated as having eight protruding tabs. To ensure that the series welds that attach the negative collector to the can are not all lying on the joints between the upwardly folded tabs, an odd number of welds, greater than the number of tabs, is preferred. In this case, at least 9 series welds are desirable for attaching the negative collector to the conductive casing. Further, the welding schedule used need not be limited to that disclosed herein. Those skilled in the art will readily recognize that a welding schedule may be adopted to accommodate the type of welding equipment being used (resistance weld, laser, etc.), the thickness and construction material of the conductive casing, the thickness and construction material of the negative collector, etc. While it is preferred that the negative collector be formed of nickel-plated steel, other materials, such as sintered nickel-plated steel and other materials may be employed in the present invention.

An energy storage device comprising a current collector in accordance with the present invention may be used for storing and supplying energy in a variety of different environments and for a variety of different purposes. For example, an energy storage device comprising a current collector in accordance with the present invention may be used for storing and supplying energy in transportation vehicles, including, for example, ground transportation vehicles, air transportation vehicles, water surface transportation vehicles, underwater transportation vehicles, and other transportation vehicles. An energy storage device comprising a current collector in accordance with the present invention may be used for storing and supplying energy in communication and entertainment devices, including, for example, telephones, radios, televisions and other communication and entertainment devices. An energy storage device comprising a current collector in accordance with the present invention may be used for storing and supplying energy in home appliances, including, for example, flashlights, emergency power supplies, and other home appliances. The examples described in this paragraph are merely representative, not definitive.

1. A current collector, comprising:
a first region, the first region of the current collector configured for establishing at least one electrical current path with an electrode of an energy storage device, the energy storage device comprising a conductive surface, and
a second region, the second region of the current collector configured for establishing at least one electrical current path with an interior surface of a container, the second region being configured for positioning between the conductive surface of the energy storage device and the container.

2. The current collector of claim 1 wherein the current collector comprises a center and a periphery and wherein the first region of the current collector is associated with the center and the second region of the current collector is associated with the periphery.

3. The current collector of claim 2 wherein the current collector is radially symmetric.

4. The current collector of claim 3 wherein the second region of the current collector comprises a plurality of radially extending tabs.

5. The current collector of claim 4 wherein the current collector is configured to enable relative movement between the plurality of radially extending tabs and the first region.

6. A method of making a current collector, comprising:
providing a conductive material,
configuring a first region of the conductive material for establishing at least one electrical current path with an electrode of an energy storage device, the energy storage device comprising a conductive surface, and
configuring a second region of the conductive material for establishing at least one electrical current path with an interior surface of a container, the second region being configured for positioning between the conductive surface of the energy storage device and the container.

7. A method of making a plurality of current collectors, comprising:
providing a conductive material,
configuring a plurality of first regions of the conductive material for establishing at least one electrical current path with an electrode of an energy storage device, the energy storage device comprising a conductive surface,
configuring a corresponding plurality of second regions of the conductive material for establishing at least one electrical current path with an interior surface of a container, the second region being configured for positioning between the conductive surface of the energy storage device and the container, such that each first region is associated with at least one second region.

8. A method of using a current collector, comprising:
establishing at least one electrical current path between a first region of the current collector and an electrode of an energy storage device, the energy storage device comprising a conductive surface, and
establishing at least one electrical current path between a second region of the current collector and an interior surface of a container, the second region being positioned between the conductive surface of the energy storage device and the container.

9. A method of using a current collector, comprising:
establishing at least one electrical current path between a first region of the current collector and an electrode of an energy storage device, the energy storage device comprising a conductive surface, and
establishing at least one electrical current path between a second region of the current collector and an interior surface of a container, the second region being positioned between the conductive surface of the energy storage device and the container.

10. An energy storage device, comprising:
an electrode comprising a conductive surface,
a container comprising an interior surface,
a current collector, the current collector comprising a first region configured for establishing at least one electrical current path with the electrode and a second region configured for positioning between the conductive surface of the electrode and the container and for establishing at least one electrical current path with an interior surface of the container.

11. The energy storage device of claim 11 wherein the current collector comprises a center and a periphery and wherein the first region of the current collector is associated with the center and the second region of the current collector is associated with the periphery.

12. The energy storage device of claim 11 wherein the current collector, the electrode and the container are radially symmetric.

13. The energy storage device of claim 12 wherein the second region of the current collector comprises a plurality of radially extending tabs.

14. The energy storage device of claim 14 wherein the current collector is configured to enable relative movement between the tabs and the first region.

15. The energy storage device of claim 14 wherein the plurality of radially extending tabs are configured to exert a force against the interior surface of the container.

16. The energy storage device of claim 11 wherein the electrode comprises an outer diameter and an inner diameter and the outer diameter and the inner diameter define a ratio of not less than 6 to 1.

17. A method comprising:
establishing at least one electrical current path between an electrode of an energy storage device and a first region of a current collector,
arranging the current collector, the energy storage device and a container so that a second region of the current collector is located between a conductive surface of the energy storage device and an interior surface of the container, and
establishing at least one electrical current path between the second region of the current collector and the container.

18. The method of claim 18 wherein the step of arranging the current collector, the energy storage device and a container comprises concentrically arranging the current collector, the energy storage device and the container

19. The method of claim 18 wherein the step of establishing at least one electrical current path between the second region of the current collector and the container comprises welding the collector and the container through an exterior surface of the container.

20. The method of claim 20 wherein the second region of the current collector comprises a plurality of N radially extending tabs, where N is an even integer, and wherein the step of establishing at least one electrical current path between the second region of the current collector and the container comprises welding the collector and the container through an exterior surface of the container at M locations, where M is an odd integer.

21. A method comprising:
establishing at least one electrical current path between an electrode of an energy storage device and a first region of a current collector,
arranging the current collector, the energy storage device and a container so that a second region of the current collector is located between a conductive surface of the energy storage device and an interior surface of the container, and
reducing electrical resistance of the energy storage device by establishing at least one electrical current path between the second region of the current collector and the container.

22. A method comprising:
establishing at least one electrical current path between an electrode of an energy storage device and a first region of a current collector,
arranging the current collector, the energy storage device and a container so that a second region of the current collector is located between a conductive surface of the energy storage device and an interior surface of the container, and
decreasing operating temperature of the energy storage device by establishing at least one electrical current path between the second region of the current collector and the container.

23. A method comprising:
establishing at least one electrical current path between an electrode of an energy storage device and a first region of a current collector,
arranging the current collector, the energy storage device and a container so that a second region of the current collector is located between a conductive surface of the energy storage device and an interior surface of the container, and
increasing current capacity of the energy storage device by establishing at least one electrical current path between the second region of the current collector and the container.

24. A method comprising:
establishing at least one electrical current path between an electrode of an energy storage device and a first region of a current collector,
arranging the current collector, the energy storage device and a container so that a second region of the current collector is located between a conductive surface of the energy storage device and an interior surface of the container, and
increasing heat rejection of the energy storage device by establishing at least one electrical current path between the second region of the current collector and the container.

25. A method comprising:
establishing at least one electrical current path between an electrode of an energy storage device and a first region of a current collector,
arranging the current collector, the energy storage device and a container so that a second region of the current collector is located between a conductive surface of the energy storage device and an interior surface of the container, and
increasing efficiency of the energy storage device by establishing at least one electrical current path between the second region of the current collector and the container.

26. A method comprising:
establishing at least one electrical current path between an electrode of an energy storage device and a first region of a current collector,
arranging the current collector, the energy storage device and a container so that a second region of the current collector is located between a conductive surface of the energy storage device and an interior surface of the container, and
extending longevity of the energy storage device by establishing at least one electrical current path between the second region of the current collector and the container.

27. A method comprising:
providing an energy storage device comprising a conductive surface and a current collector, the current collector comprising:
a first region configured for establishing at least one electrical current path with an electrode of the energy storage device, and
a second region configured for establishing at least one electrical current path with an interior surface of a container, the second region being configured for positioning between the conductive surface of the energy storage device and the container, and
accessing energy stored in the energy storage device.

28. An apparatus comprising:
an energy storage device, and
a configuration enabling use of energy stored in the energy storage device,
the energy storage device comprising a conductive surface and a current collector, the current collector comprising:
a first region configured for establishing at least one electrical current path with an electrode of the energy storage device, and
a second region configured for establishing at least one electrical current path with an interior surface of a container, the second region being configured for positioning between the conductive surface of the energy storage device and the container.

29. The current collector of claim 1, wherein the first region of the current collector is configured for establishing at least one electrical current path with an electrode of a coiled energy storage device, the coiled energy storage device comprising a curved conductive surface, and the second region of the current collector is configured for positioning between the curved conductive surface of the coiled energy storage device and the container.

30. The current collector of claim 6, wherein the first region of the current collector is configured for establishing at least one electrical current path with an electrode of a coiled energy storage device, the coiled energy storage device comprising a curved conductive surface, and the second region of the current collector is configured for positioning between the curved conductive surface of the coiled energy storage device and the container.
